(19) United States
(12) Patent Application Publication
(10) Pub. No.: US 2005/0144839 A1
(43) Pub. Date: Jul. 7, 2005

(54) Plant support

(75) Inventors: Pete M. Morgan, Cincinnati, OH (US); Kristi L. Davidson, Cincinnati, OH (US)

Correspondence Address: Mr. Pete Morgan, 1500 Clovermoll Drive, Cincinnati, OH, 45231, US

(73) Assignee: Pete M. Morgan, Cincinnati, OH (US)

(21) Appl. No.: 10/751,566

(22) Filed: Jan. 5, 2004

(51) Int. Cl. A01G 9/12

(52) U.S. Cl. 47/45

(57) ABSTRACT

An improved plant support with a plurality of upright members that form corners of a polygonal shape. The upright members are interconnected by a plurality of individualized legs that are removably connected to upright members to form a stand alone plant support structure. The legs have elongate bodies terminating in a pair of adjustable flanges. The flanges may include a hinge or a flange end cap connecting the flange to the elongate body. A plant support matrix may be formed from a plurality of individual plant supports. The plant supports may be in abutting relation or interconnected to form the matrix.

### FIELD OF THE INVENTION

This invention relates to a plant support and more particularly, to improved ground supports for fruit, vegetables and other vegetation to support the weight of the various plant parts to sustain them during their growing period.

### BACKGROUND OF THE INVENTION

This is an improvement on commonly owned U.S. Pat. No. 4,785,576 issued to Morgan, which is hereby incorporated by reference herein in its entirety. It is common knowledge in the art that the control of certain parameters connected with the growth of plants can effectually control the growth, flavor, texture, aroma, quantity of output, configuration and shape of output, and any number of additional characteristics of the plant, its flowers, fruit or any other product a plant may produce. Likewise, it is considered desirable, if possible to suspend the fruit of a plant above the ground to decrease the incidence of spoilage and parasitic attack of the fruit, and in the case of flowers and foliage, to support the plant so that the flowers and/or foliage may provide a pleasing appearance and be easily accessible. Such elevation of plant parts also has the benefit of enhancing plant growth due to more of the plant surface being exposed to the atmosphere and a ready and constantly circulating supply of gaseous nutrients, and thereby also more effectively removing waste products. Additionally, there is evidence that movement of the plant, such as that induced by the wind blowing the plant about, is beneficial to plant growth by producing a greater robustness and strength in the plant.

In the past, numerous attempts to control the plant's physical environment have met with some degree of success, in some cases justifying the efforts required so that the method has become common practice. One such practice is the provision of a support for the plant so that as the plant grows it is possible to prevent the plant from lying directly on the ground. As disclosed in the inventor's prior patent, these support generally take the form of stakes driven into the ground, circular wire meshes and the like, and are generally exceedingly simple structures often constructed of scrap materials and intended to last only one growing season. These structures often lack in durability, resulting in collapse of the support during the growing season, spoilage of the plant and/or its product and disposal problems thereafter.

Other attempts to provide desirable supports have resulted in supports that, although durable and intended to last through an indefinite number of growing seasons, have been either overly bulky in storage, expensive to manufacture and purchase, difficult to assemble, or failed in their intended purpose, that usually being to increase productivity of the plant. Moreover, current support systems do not allow the grower to tailor the support structure to their specific needs and desires as determined by the types of plants to be supported, the environment in which the plant is to be supported, and the personal tastes of the grower.

There is thus a need for an improved plant support that has the benefits of low cost, simplicity, ease of repair, durability, compact storage, and effectiveness while having versatility in support structure designs to meet the specific needs of the grower.

### SUMMARY OF THE INVENTION

The present invention provides a plant support that is an improvement over the prior art support structures. To this end, the present invention provides a plurality of upright members that form corners of a plant support having a polygonal shape. The upright members are interconnected by a plurality of individualized legs that each include a pair of adjustable flanges at opposed ends of the leg. The legs are removably coupled to the upright members to form a stand-alone plant support structure having the features described above.

More particularly, the upright members include a plurality of holes formed therethrough vertically spaced along the upright member and the flanges also include a hole therethrough, the holes cooperating to secure a leg to an upright member by, for example, a nut and bolt. The legs comprise an elongate body terminating with a pair of opposed flanges that may be adjustably angled with respect to the elongate body. The flanges may include a hinge to connect to the elongate body, or alternatively, a flange end cap may be provided with one end adapted to secure to the elongate body and the other end including a hinge connecting the flange to the end cap.

Individualized legs having adjustable flanges provide versatility in designing a plant support for a wide variety of applications. For example, a plant support of the present invention may be triangular, square, pentagonal, hexagonal, octagonal, or virtually any other desired shape based on such factors as the type of plants the structure is supporting, the desired strength of the structure, as well as the personal and aesthetic tastes of the grower.

Moreover, while the present invention may be a stand alone plant support, the present invention further contemplates a plant support matrix comprising a plurality of plant supports of the above construction coupled together to form a complex plant support matrix, such as for example, to support an entire row of plants in a garden, provide support for an artistically arranged flower garden, lawn planting, or the like. The plurality of plant supports comprising the matrix may be arranged in abutting relation to each other or may alternatively be interconnected by, for example, a nut and bolt.

By virtue of the foregoing, there is thus provided a plant support that is low cost, simple, easy to repair, durable, effective in enhancing plant production and versatile so as to allow the grower to design the plant support to meet his/her needs and desires. These and other advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the present invention.

FIG. 1 is a perspective view of a triangular plant support in accordance with the present invention;

FIG. 2 is a top plan view of the plant support of FIG. 1;

FIG. 3 is a disassembled enlarged view of the coupling method of the legs and upright members as shown in FIGS. 1-2;

FIG. 4 is a side elevation view of the legs showing the flange angles formed by the flanges on opposed ends of the legs;

FIG. 5 is an enlarged perspective view of a leg having a hinged flange in accordance with the present invention.

FIG. 6 is an enlarged perspective view of a leg having a flange end cap in accordance with the present invention.

FIG. 7A-B are a top plan view of an alternate embodiment of a triangular plant support in accordance with the present invention;

FIG. 8 is a top plan view of a plant support matrix in accordance with the present invention formed by abutting singly self supported plant supports;

FIG. 9 is a top plan view of a unitary plant support matrix in accordance with the present invention showing interconnected plant supports; and,

FIG. 10 is a perspective view of a hexagonal plant support having inwardly angled upright members and an open area adjacent the top end of the plant support.

### DETAILED DESCRIPTION

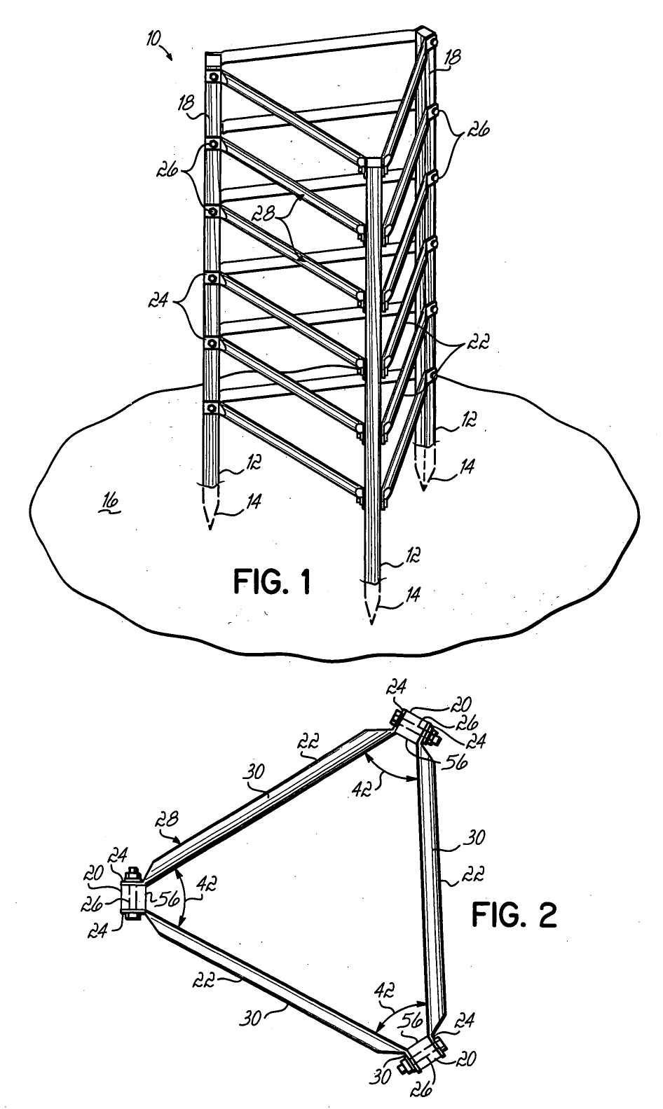

With reference to FIGS. 1-2, there is shown a triangular plant support 10 in accordance with the present invention. The plant support 10 includes three upright members 12 each having a bottom portion 14 coupled to a surface 16 which, for example could be the ground or the floor of one's home or patio, and a top portion 18 vertically or nearly vertically extending away from the surface 16. The term “upright” refers to a vertical orientation (i.e., angled 90 degrees with respect to the surface) or a nearly vertical orientation, such as angled not less than 45 degrees with respect to surface 16, and advantageously not less than 60 degrees with respect to surface 16. The upright members 12 form the corners 20 of a plant support 10 having a polygonal shape (FIG. 2). The upright-members 12 are interconnected by a plurality of individualized legs 22, each leg 22 having an elongate body 30 terminating in a pair of flanges 24 and adapted to removably couple to the upright members 12 to form a stand alone plant support 10.

More particularly, upright members 12 each include a plurality of holes 26 formed therethrough, and advantageously oriented horizontally therethrough, and vertically spaced along the length of upright members 12. The bottom portion 14 of upright members 12 may be pointed to facilitate driving upright members 12 into the ground, or alternatively, may be configured to stand on top of a solid floor, such as the floor of a greenhouse or patio. Advantageously, upright members 12 are made from wood but may also be made from metal tubing, plastic, or other suitable material of sufficient strength. Additionally, upright members 12 are advantageously square in cross section though the invention is not so limited.

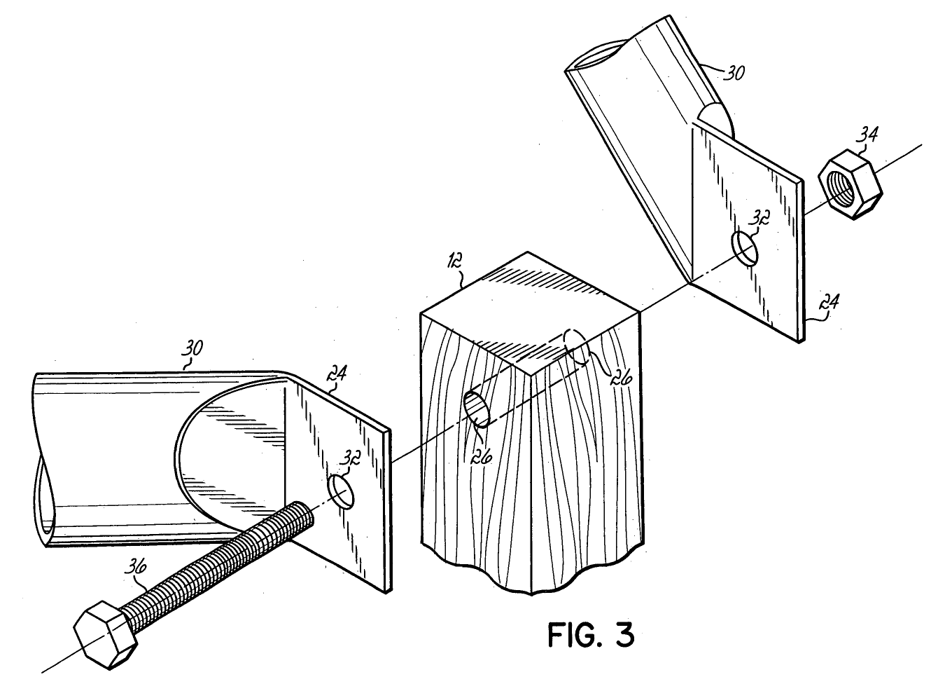

Individual legs 22 may be arranged into a plurality of support members 28. Advantageously, support members 28 are horizontal or nearly horizontal with respect to surface 16 by virtue of the legs 22 being coupled to the upright members 12 in a horizontal or nearly horizontal orientation. As shown in the exemplary embodiment of FIGS. 1-2, three individualized legs 22 are removably coupled to the upright members 12 to form a support member 28. Each leg 22 includes an elongate body 30, that may for example take the form of cylindrical tubing, and that terminates in a pair of opposed flanges 24. As most clearly shown in the enlarged view of FIG. 3, each flange 24 has a hole 32 therethrough adapted to be coupled to a corresponding hole 26 in an upright member 12 by known means, such as a nut 34 and bolt 36. As further shown in FIG. 3, each nut 34 and bolt 36 advantageously couples at least two flanges 24 to the same or opposed sides of an upright member 12.

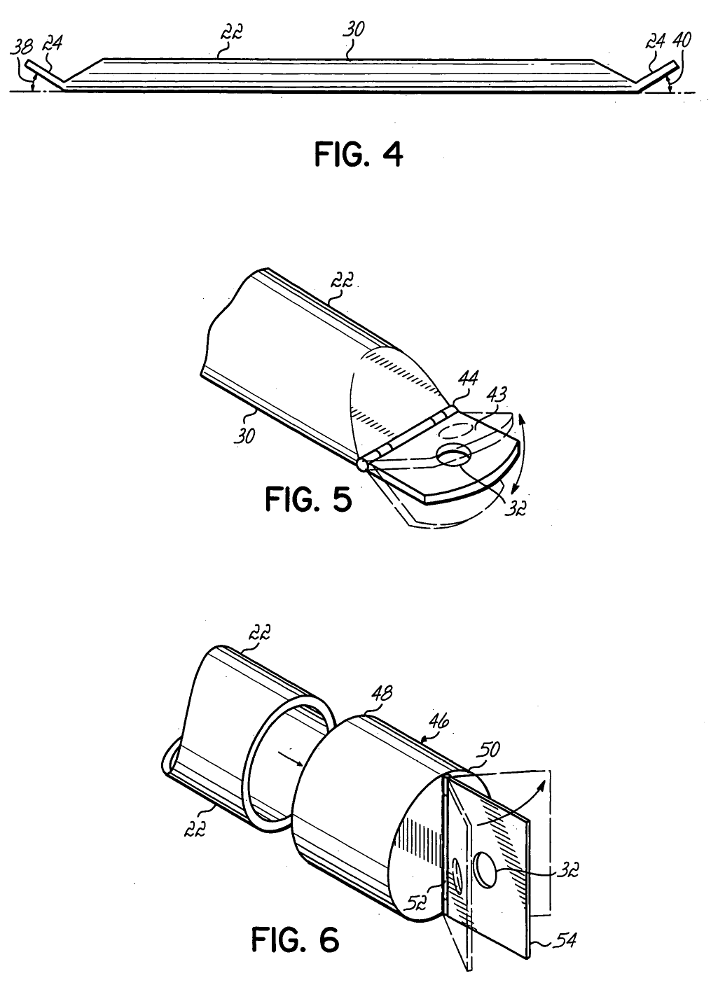

As shown in FIG. 4, flanges 24 of leg 22 may be adjustably angled with respect to the elongate body 30 of leg 22, forming angles 38, 40. These angles 38, 40 may be equal to each other but are not so limited. Angles 38, 40 that flanges 24 make with elongate body 30 depend on the type of plant support 10 being designed. For instance, if the polygonal shape of the structure is regular, i.e., having legs 22 of equal length and included angles 42 (FIG. 2) of equal value, then the angles 38, 40 are equal and can be calculated as one half of the included angle 42. As shown in FIG. 2, for a regular triangular structure, the included angles 42 are 60 degrees and the flanges 24 are angled with angles 38, 40 at approximately 30 degrees. For a square support (e.g., support 60c in FIG. 8) having included angles 42c of 90 degrees, the flanges 24 are angled with angles 38, 40 at approximately 45 degrees. For the hexagonal structure (e.g., support 60d in FIG. 8) having included angles 42d of 120 degrees, the flanges 24 are angled with angles 38, 40 at approximately 60 degrees. Thus by adjusting the angles 38, 40 that the flanges 24 make with the elongate body 30 of legs 22, different polygonal shaped structures may be formed to suit the particular desires and needs of the grower.

It is to be understood, however, that the shape of the plant support 10 does not have to be regular, and by adjusting the flange angles 38, 40 as needed, a wide variety of plant supports may be designed. Flanges 24 of legs 22 may be adjusted in several ways. For instance, if legs 22 are made from a pliable material, such as an aluminum alloy or other material known in the art, then flanges 24 may be adjusted by simple bending, such as for example using a pair of pliers and perhaps a vise to hold leg 22. In one exemplary embodiment of the present invention, depicted in FIG. 5, flange 43 may advantageously include hinge 44 connecting flange 43 to elongate body 30 of leg 22. In this way, flange angles 38, 40 may be easily and quickly adjusted to a desired angle as required by a particular plant support design. Alternatively, and as shown in FIG. 6, legs 22 may include a flange end cap 46 having a first end 48 adapted to couple to the elongate body 30 of a leg 22 and a second end 50 including a hinge 52 connecting flange 54 to end cap 46. Again with end caps 46, angles 38, 40 may be easily and quickly adjusted to a desired angle as required by a particular plant support design.

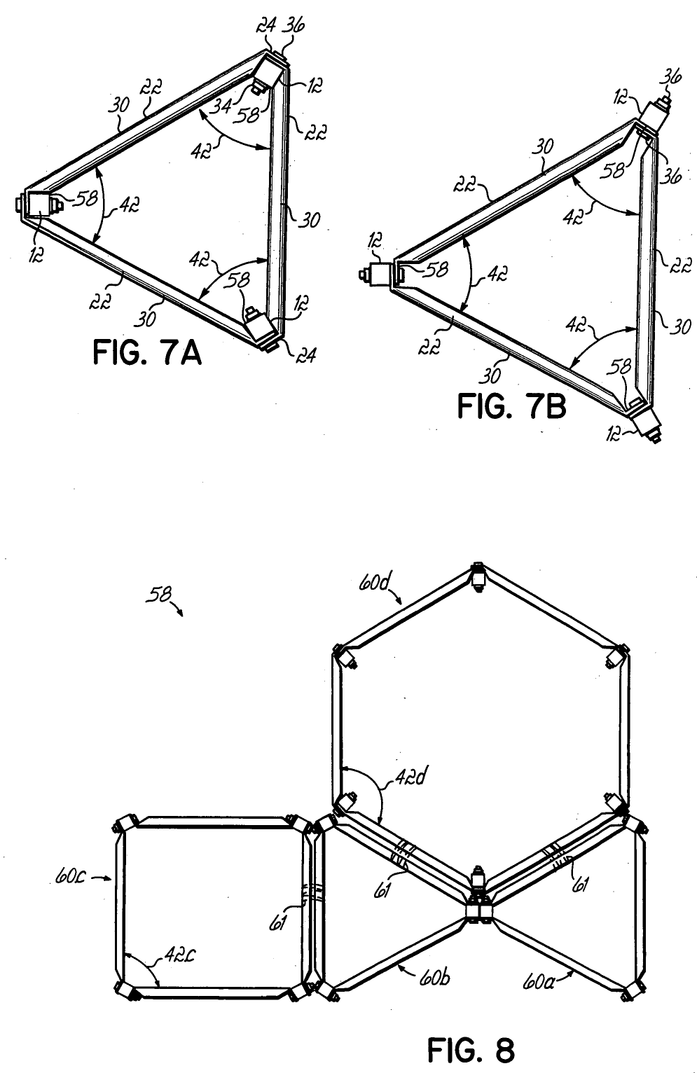

The flange angles 38, 40 also depend on the orientation of the holes 26 in upright members 12. For instance, as shown in FIG. 2, the upright,members 12 have a surface 56 facing the interior of the polygonal shape formed by upright members 12 that does not include holes 26, i.e., the head of bolt 36 and nut 34 are outside the polygonal shape formed by upright members 22. In this case, to construct a regular polygonal shape, the flange angles are determined as-above. As shown in FIGS. 7A and B, however, upright members 12 can be oriented such that a surface 58 including either the head of bolt 36 or nut 34 is interior to the polygonal shape formed by upright members 12. When the upright members 12 are oriented in this manner, then legs 22 may be coupled to upright members 12 with upright members 12 interior to the polygonal shape, as shown in FIG. 7A, or with upright members 12 exterior to the polygonal shape, as shown in FIG. 7B.

The flange angles 38, 40 for the configurations shown in FIGS. 7A and B are the same but do not equal the flange angles 38, 40 when the upright members 12 are oriented as shown in FIG. 2. For a regular polygonal shaped plant support having the orientation of upright members 12 as shown in FIGS. 7A and B, angles 38, 40 can be calculated as 90 degrees minus one half of the included angle 42 (for a triangle, or 42c for a square or 42d for a hexagon). Thus for example, when the upright members 12 are oriented in the manner shown in FIGS. 7A and B, then for a regular triangle, flanges 24 are angled with angles 38, 40 at approximately 60 degrees; for a square, flanges 24 are angled with angles 38, 40 at approximately 45 degrees; and for a regular hexagon, flanges 24 are angled with angles 38, 40 at approximately 30 degrees. Thus using legs 22 with flanges 24 angled with angles 38, 40 at approximately 30 degrees, a grower may design a regular triangular plant support with upright members 12 having the orientation as shown in FIG. 2, or a regular hexagonal plant support 60d (FIG. 8) with upright members 12 having the orientation as shown in FIG. 7A or B. A regular triangular or hexagonal plant support may also be designed using legs 22 having flanges 24 angled with angles 38, 40 at approximately 60 degrees. For a square support, such as support 60c in FIG. 8, the upright members 12 may be oriented such as that shown in FIG. 2 or FIG. 7A or B and in each case, legs 22 have flanges 24 angled with angles 38, 40 at approximately 45 degrees. It should be realized, however, that upright members 12 may have holes 26 oriented in any manner and legs 22 coupled to upright members 12 by adjusting flange angles 38, 40 to the required angle.

As shown in FIGS. 1-7, the plant support of the present invention may be used to design single self-supporting, polygonal shaped plant supports. Referring now to FIG. 8, a plant support matrix 58 in accordance with the present invention may be designed by assembling multiple single self-supporting plant supports 60a, 60b, 60c, 60d, similar to that shown in FIG. 1, and abutting them together to form a support matrix 58. This process of abutting single plant supports 60 may continue in any desired manner to build a wide variety of plant support matrix designs 58. For instance, FIG. 8 shows four plant supports 60a, 60b, 60c, 60d abutted together to form matrix 58 that, for example, could support plants along a row in a garden or a decorative landscape design. Moreover, as shown in FIG. 8, plant supports 60 may have different polygonal shapes, such as triangles 60a, 60b, square 60c, and hexagon 60d to form a more aesthetically pleasing or artistic plant support matrix 58 design. The plant supports 60a-d may be tied together with, for example, rope 61 (shown in phantom).

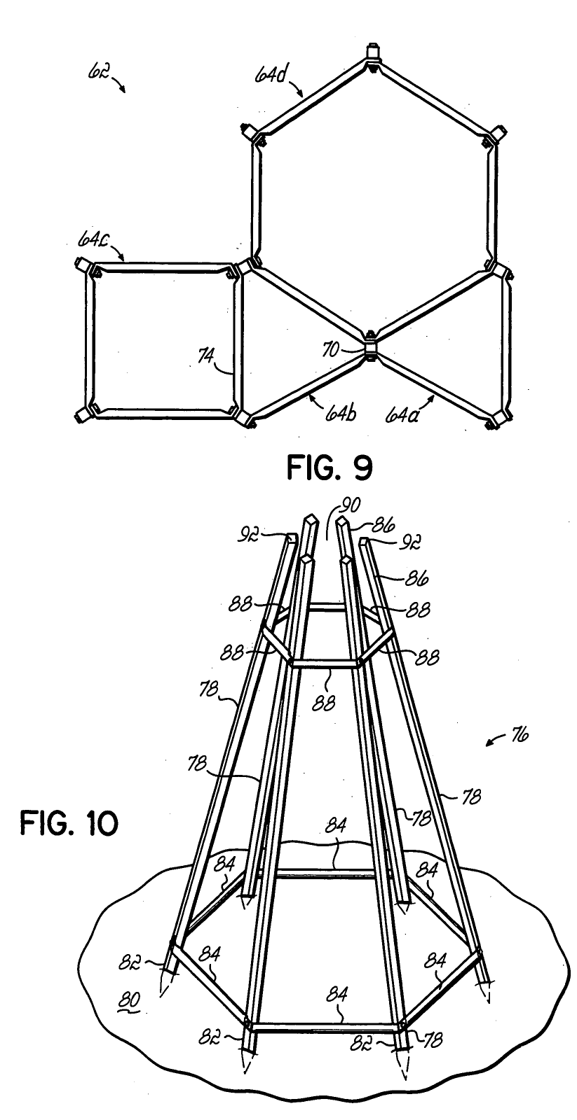

As shown in FIG. 9, however, a unitary plant support matrix design 62 may be assembled in accordance with the present invention with single plant supports 64a, 64b, 64c, 64d interconnected. The unitary plant support matrix 62 has the advantages of using less material, reducing costs, reducing hardware requirements, and providing a stronger plant support matrix. For instance, the two triangular plant supports 64a, 64b have a common upright member 70. Moreover, triangular support 64b and square support 64c share a common leg 74. A unitary design may reduce the number of upright members 12 and/or the number of legs 22 that interconnect upright members 12, as well as the hardware to attach legs 22 to upright members 12. By way of example, matrix 58 of FIG. 8 uses sixteen upright members 12, sixteen legs 22 along a single horizontal plane, and sixteen nuts and bolts, whereas matrix 62 of FIG. 9 uses only ten upright members 12, thirteen legs 22 and 10 nuts and bolts. Additionally, the unitary plant support matrix 62 may have different polygonal shapes. For instance, FIG. 9 shows two triangular supports 64a, 64b, a square support 64c, and a hexagonal support 64d interconnected to each other in the same matrix 62. This allows the grower to design a plant support matrix to his/her particular tastes and desires.

In another aspect of the invention, and as shown in FIG. 10, a hexagonal plant support 76 has upright members 78 that are inwardly angled with respect to surface 80, such as the ground. Plant supports, such as plant support 76, having upright members that are not orthogonal to surface 80 but are inwardly angled may be characterized as having an interior plant support area that is maximum at the base of the plant support and decreasing in the vertical direction. Adjacent bottom portion 82 of upright members 78, the upright members 78 are interconnected by legs 84. Instead of a tee-pee style plant support, characterized by the upright members 78 contacting one another adjacent the top portions 86 to support the upright members 78 (not, shown), plant support 76 is secured adjacent top portions 86 by interconnected legs 88. Legs 88 are configured to provide an open area 90 interior to the top ends 92 of upright members 78, whereby the upright members 78 are supported without contacting each other directly. The open area 90 is advantageous in providing enhanced air flow around the plant, thus increasing plant production.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. The invention in its broader aspects is, therefore, not limited to the specific details, representative apparatus, and illustrative examples shown and described. Accordingly, departures may be made from such details without departing from the spirit or scope of the general inventive concept.

1. A plant support structure engaging a generally planar surface comprising:
a plurality of upright members each having a top and bottom portion, said bottom portion engaging the surface and each of said plurality of upright members defining a corner of a polygonal shape; and
a plurality of individualized legs interconnecting said plurality of upright members and each leg having an elongate body terminating in a pair of opposed adjustable flanges removably coupled to said upright members to thereby form a self-supporting structure.

2. The plant support structure of claim 1 wherein each of said plurality of upright members is angled at approximately 90 degrees with respect to the surface.

3. The plant support structure of claim 1 wherein each of said plurality of upright members is angled at no less than 45 degrees with respect to the surface.

4. The plant support structure of claim 1 wherein each of said upright members further comprises a plurality of holes therethrough, said holes vertically spaced along'said upright members for coupling said flanges to said upright members.

5. The plant support structure of claim 1 wherein each of said plurality of upright members is made from at least one of a wood, plastic and metal.

6. The plant support structure of claim 1 wherein each of said plurality of upright members is square in cross section.

7. The plant support structure of claim 1 wherein said bottom portion of each of said plurality of upright members is pointed.

8. The plant support structure of claim 1 wherein each of said flanges on each of said legs further comprises a hole therethrough for coupling said flanges to at least one of said plurality of upright members.

9. The plant support structure of claim 1 wherein said pair of opposed adjustable flanges define a first angle and a second angle, respectively, with respect to said elongate body, and wherein said first and second angles are equal to each other.

11. The plant support structure of claim 1 wherein each of said flanges further comprises a hinge connecting said flange to said elongate body.

12. The plant support structure of claim 1 further comprising a plurality of flange end caps, each flange end cap having a first end coupled to said elongate body and a second end including a hinge coupled to said flange.

13. The plant support structure of claim 1 wherein said plurality of legs are arranged to form one or more support members substantially horizontal with respect to the surface.

14. The plant support structure of claim 1 wherein said plurality of legs are made from a metal tubing.

15. The plant support structure of claim 1 wherein said polygonal shape is selected from the group consisting of a triangle, square, pentagon, hexagon and octagon.

16. A plant support matrix comprising a plurality of plant supports of claim 1.

17. The plant support matrix of claim 16 wherein said plurality of plant supports are arranged in abutting relation to form said matrix.

18. The plant support matrix of claim 17 wherein said matrix comprises at least two plant supports having different polygonal shapes.

19. The plant support matrix of claim 16 wherein said plurality of plant supports are interconnected to form a unitary plant support matrix.

20. The plant support matrix of claim 19 wherein said matrix comprises at least two plant supports having different polygonal shapes.

21. The plant support structure of claim 1 wherein said plurality of upright members are angled with respect to the surface to define a plant support area that is decreasing in an upward vertical direction, and wherein said plurality of upright members do not directly contact each other so as to define an open plant support area at a top end of said plant support.

22. A plant support matrix engaging a generally planar surface comprising:
a plurality of upright members each having a top and bottom portion, said bottom portion engaging the surface and said plurality of upright members arranged so as to form a plurality of interconnected polygonal shapes with each of said plurality of upright members defining a corner of said plurality of interconnected polygonal shapes; and
a plurality of individualized legs interconnecting said plurality of upright members and each leg having an elongate body terminating in a pair of opposed adjustable flanges removably coupled to said upright members to form a self-supporting structure.

23. The plant support matrix of claim 22 wherein each of said plurality of upright members is angled at approximately 90 degrees with respect to the surface.

24. The plant support matrix of claim 22 wherein each of said plurality of upright members is angled at no less than 45 degrees with respect to the surface.

25. The plant support matrix of claim 22 wherein each of said upright members further comprise a plurality of holes therethrough, said holes vertically spaced along said upright members for coupling said flanges to said upright members.

26. The plant support matrix of claim 22 wherein each of said plurality of upright members is made from at least one of a wood, plastic and metal.

27. The plant support matrix of claim 22 wherein each of said plurality of upright members is square in cross section.

28. The plant support matrix of claim 22 wherein said bottom portion of each of said plurality of upright members is pointed.

29. The plant support matrix of claim 22 wherein each of said flanges on each of said legs further comprises a hole therethrough for coupling said flanges to at least one of said plurality of upright members.

30. The plant support matrix of claim 22 wherein said pair of opposed adjustable flanges define a first angle and a second angle, respectively, with respect to said elongate body, and wherein said first and second angles are equal to each other.

31. The plant support matrix of claim 22 wherein each of said flanges further comprises a hinge connecting said flange to said elongate body.

32. The plant support matrix of claim 22 further comprising a plurality of flange end caps, each flange end cap having a first end coupled to said elongate body and a second end including a hinge coupled to said flange.

33. The plant support matrix of claim 22 wherein said plurality of legs are arranged to form one or more support members substantially horizontal with respect to the surface.

34. The plant support matrix of claim 22 wherein said plurality of legs are made from a metal tubing.

35. The plant support matrix of claim 22 wherein each of said interconnected polygonal shapes is selected from the group consisting of a triangle, square, pentagon, hexagon and octagon.

36. The plant support matrix of claim 22 wherein said matrix comprises at least two plant supports having different polygonal shapes.

37. A plant support kit for assembling a plant support structure comprising:
a plurality of upright members each having a top and bottom portion, said bottom portion for engaging a generally planar surface; and
a plurality of individualized legs for interconnecting said plurality of upright members and each leg having an elongate body terminating in a pair of opposed adjustable flanges adapted to removably couple to said upright members to thereby form a self-supporting structure.

38. The plant support kit of claim 37 wherein each of said upright members further comprises a plurality of holes therethrough, said holes vertically spaced along said upright members for coupling said flanges to said upright members.

39. The plant support kit of claim 37 wherein each of said plurality of upright members is made from at least one of a wood, plastic and metal.

40. The plant support kit of claim 37 wherein each of said plurality of upright members is square in cross section.

41. The plant support kit of claim 37 wherein said bottom portion of each of said plurality of upright members is pointed.

42. The plant support kit of claim 37 wherein each of said flanges on each of said legs further comprises a hole therethrough for coupling said flanges to at least one of said plurality of upright members.

43. The plant support kit of claim 37 wherein each of said flanges further comprises a hinge connecting said flange to said elongate body.

44. The plant support kit of claim 37 further comprising a plurality of flange end caps, each flange end cap having a first end adapted to couple to said elongate body and a second end including a hinge adapted to couple to said flange.

45. The plant support kit of claim 37 wherein said plurality of legs are made from a metal tubing.
